(19) United States
(12) Patent Application Publication
(10) Pub. No.: US 2011/0081528 A1
(43) Pub. Date: Apr. 7, 2011

(54) Dry Wipe for Hard Surface Germ Control

(76) Inventors: Thomas Gerard Shannon, Neenah, WI (US); Maurizio Tirimacco, Appleton, WI (US); Bao Trong Do, Decatur, GA (US); Megan Kathryn Millard, Appleton, WI (US); Raegan Elyse Allen, New London, WI (US)

(21) Appl. No.: 12/571,548

(22) Filed: Oct. 1, 2009

(51) Int. Cl. B32B 3/10

(52) U.S. Cl. 428/211.1

(57) ABSTRACT

Dry paper towel sheets are provided with a cleaning-related scent and a functional visual indicia to indicate the capability of the sheets to remove 99 or greater percent of germs when used to wipe hard surfaces.

### BACKGROUND OF THE INVENTION

Dishrags, sponges and other durables are used routinely by consumers to wipe down kitchen surfaces and keep surfaces free from germs. However, because these items are frequently stored in a damp condition, they often harbor a large number of germs which can proliferate and thereafter be transferred to surfaces during wiping. As a consequence, their repeated use may in fact be counterproductive in terms of eliminating germs.

Another common approach to clean surfaces of germs is to spray a cleaning solution onto the surface and then wipe the surface with a paper or cloth towel. Yet another approach is to use commonly available moist disinfecting or cleaning wipes. The use of spray cleaners or moist disinfecting wipes adds a level of complexity and inconvenience to the cleaning process. Cleaning fluids and disinfecting wipes are relatively high in cost compared to paper towels. Both cleaning fluids and moist disinfecting wipes typically contain chemicals that are toxic or not meant for skin contact. Due to the toxic nature of the ingredients, cleaning fluids and moist wipes are usually stored away from the countertop and thus not always conveniently located for quick use. The need to locate the product away from the point of use can reduce the frequency of use of the germ control product and thus reduce the effectiveness of the protection sought by the consumer. Furthermore, moist cleaning and disinfecting wipes must be contained in a special container to prevent the cleaning or disinfectant solution from drying out.

Therefore there is a need for an inexpensive and effective germ-removing wiping product that is handy for consumers to use.

### SUMMARY OF THE INVENTION

It has been unexpectedly discovered that certain dry paper towels are very good at removing germs from hard surfaces. While not wishing to be bound by theory, it is believed that frictional forces between the surface and the paper towel are responsible for dislodging the germs from the surface. The dislodged germs are then sequestered within the pore structure of the cellulosic sheet and prevented from re-depositing on the cleaned surface. In fact, it has been determined that such paper towels can remove over 99% of the germs from a non-porous surface in the absence of any disinfectants or surfactant-containing cleaning solutions. Germ removal is aided by moisture, which may either be present as part of the contamination already present on the surface or may be applied by the consumer, either to the surface or directly to the paper towel sheet. However, as germs are invisible entities, the consumer has no way to visually discern the germ removal performance of a product. Thus, while simple wetting of a paper towel may allow the towel to do an excellent job of removing germs, consumers have been conditioned to believe that additional cleaning products, such as disinfectants or secondary cleaners, are needed to remove the germs from hard surfaces. Thus, consumers are not aware of the effectiveness and convenience that paper towels can provide for germ control.

Hence, in one aspect the invention resides in a dry wiping product comprising a paper towel sheet containing a fragrance, which emits a cleaning-related scent, and a visual functional indicia consisting essentially of cool colors. The presence of a cleaning-related scent and a functional visual indicia gives the user confidence that the product is effective for removing germs during wiping.

For purposes herein, the term “fragrance” means a composition of one or more volatile compounds that emits or otherwise provides an odor or scent. The term “scent” refers to the description of the smell or odor resulting from the presence of the fragrance. A “cleaning-related scent” is a scent that is generally recognized by consumers as being associated with cleaning. For the purposes herein, a fragrance can comprise a combination of one or more individual fragrances and possess one or more scents.

A variety of classification systems may be used to describe the scents associated with fragrances. They break the fragrances into various scent categories describing the fragrance in relationship to scents associated with familiar objects or experiences. Trained scent or fragrance experts are used to assign the scent or scents of a fragrance into the various categories. Trained scent experts are capable of further describing scents in terms of various combinations of scents or scent notes. Due to advances in technology of fragrance creation through chemical compound design and synthesis, as well as the natural development of styles and tastes, categories are continually emerging to describe “new” fragrance scents. A traditional set of classifications well known to those skilled in the art comprises the following scent categories:
Single Floral: scents that are dominated by a scent from one particular flower;
Floral Bouquet: scents containing the combination of several flowers in a scent;
Amber: a large scent class featuring the sweet slightly animalic scents of ambergris or labdanum, often combined with vanilla, flowers and woods. These scents may be enhanced by camphorous oils and incense resins, which bring to mind Victorian era imagery of the Middle East and Far East;
Wood: scents that are dominated by woody scents, typically of agarwood, sandalwood and cedar;
Leather: a family of scents which features the scents of honey, tobacco, wood and wood tars in its middle or base notes and a scent that alludes to leather;
Chypre: scents built on an accord consisting of bergamot, oakmoss, patchouli, and labdanum;
Fougère: meaning “fern” in French, scents built on a base of lavender, coumarin and oakmoss;
Bright Floral: scents combining the traditional Single Floral & Floral Bouquet categories;
Green: a lighter and more modern interpretation of the Chypre type scents, with pronounced cut grass and cucumber-like scents;
Aquatic, Oceanic, or Ozonic: scents having a very clean, modern scent. Often contains the synthetic scent, calone.
Citrus: an old scent family referring to scents similar to those of the fruits of the genus Citrus L. from the family of the Rutaceae;
Fruity: scents featuring the aromas or scents of fruits other than citrus, such as peach, cassis (black currant), mango, passion fruit, and others; and
Gourmand: scents associated with non-fruit “edible” or “dessert”-like qualities. These scents often have notes like vanilla, tonka bean and coumarin, as well as having synthetic components designed to resemble food flavors.

Fragrance formulations can be quite complex. Fragrance formulations may be dominated by complex ingredients and odorants that are of little use in providing a guide to the general description of the scent's olfactive family. However perfume and fragrance experts can be extremely skillful at identifying components and origins of the scents within the fragrance. Scent taxonomy may point to complexities of the fragrance, identifying scents from scent families within the fragrance. For example, a fragrance that might be described as having a Single Floral scent may have undertones of other scents. At other times, a fragrance may be made that combines a Fruity scent with a Citrus scent, such as combining a mango scent with a lime scent, to give a fruity citrus-like scent.

The most practical way to describe the scent of a fragrance is according to the individual elements or “notes” of the scent or the scent family to which it belongs. For purposes of this invention, such classifications will generally be accomplished by trained fragrance/scent/odor experts. “Top notes”, sometimes also referred to as “primary” or “head” notes, refer to the scents that are perceived immediately or most strongly perceived upon first exposure to the fragrance. Top notes will typically consist of the smaller, lighter molecules of the fragrance composition that evaporate more quickly than other odoriferous components of the fragrance. They form a person's initial impression of the fragrance.

For purposes herein, particularly suitable “cleaning-related scents” will have at least one top note selected from the Citrus, Green, Fruity, Aquatic, Wood, Chypre or Fougère scent categories. More specifically, the cleaning-related scent may be described as having a “fresh” scent, which means a scent having a top note selected from the Green, Fruity or Aquatic scent categories. Particularly preferred fragrances are those which provide scents having top notes in the Citrus category. The presence of the above-identified scents conveys the message that the product is an effective cleaning product. Preferably the fragrance is selected such that the resulting scent is absent of strong notes from the amber category such as scents that would be described as animal like (musk, castoreum, skatole, civet, ambergris), camphorous (includes menthol, eucalyptus etc), balsamic (cocoa, vanilla, cinnamon), metallic, fatty or waxy. The cleaning-related scent may comprise notes from the Floral categories, however, it is preferable that these are not the primary note of the scent. Furthermore, when a Floral note is present, it is preferable that a Citrus or Fresh note be present and be the primary note of the scent.

Besides top notes, the fragrance scents of the present invention may also provide “middle” and “base” notes. The terms “middle” and “base” notes are well known to those skilled in the art of scents and fragrances. The middle and base notes, if present, may be selected from any of the scent categories. As used herein, a middle note refers to the scent of a fragrance that emerges just prior to the point when the top note(s) dissipate. These middle notes may be used to mask an unpleasant initial impression of the base notes, which may become more pleasant with time. A base note, as used herein, refers to the scent of the fragrance that appears close to the departure of the middle notes. In a preferred embodiment of the present invention, the base and middle notes, if present, of the fragrance scents of the present invention are selected from the Citrus, Fruity, Aquatic, Green, Fougère, Chypre, or Wood categories and, most preferably, from the Citrus, Fruity, Aquatic and Wood categories.

The fragrance compositions of the present invention may contain one or more ingredients, suitably from about 10 to about 100 or more ingredients. The top, middle, and base notes of a fragrance scent may have separate primary and supporting ingredients. The fragrance oils and compounds may be blended with diluents. “Primary” ingredients, as used herein, refers to the few main ingredients of a fragrance that are used to create a certain “primary” scent, such as a lemon scent. Multiple fragrance ingredients can be used together to create an “abstract” scent that does not bear a resemblance to a natural scent. For instance, jasmine and rose fragrance ingredients may be blended for an abstract floral scent. However, for purposes of this invention, the fragrances preferably provide a scent bearing a resemblance to a natural scent.

The fragrances of the present invention may also comprise “modifiers”. As used herein, modifiers are ingredients that alter the primary scent of the fragrance to give the resulting scent a certain desired character. For example, Citrus fragrance ingredients may be combined with the primary ingredients of a Fruity fragrance to create a fruity citrus scent, such as mango-lime. Modifiers may also be used to influence the top, middle or base notes of the resulting scent.

The fragrances of the present invention may also comprise “blenders”. Blenders are a large group of ingredients that smooth out the transitions between different bases or notes. Common blending ingredients include compounds such as linalool and hydroxycitronellal.

The fragrances of the present invention may also comprise “fixatives” or “diluents”. Fixatives or diluents are materials incorporated into a fragrance for the purpose of retarding the volatilization of the fragrance oil when it is applied to a surface to increase its longevity or to produce a more uniform volatilization of the scents so that the fragrance does not rapidly change over time. Common fixatives include natural gums and high boiling point chemicals such as, but not limited to, dipropylene glycol, isopropyl myristate, isopropyl palmitate, tripropylene glycol, benzyl salicylate and the like. Some fixatives may have an odor of their own which is taken into account when creating a fragrance.

Suitable fragrances may be derived from the oils of the natural plants or from synthetic or natural compounds, such as trans-2-octenal, trans-2-decenal, trans-2-undecenal, citral, (Z)-8-tetradecenal, (E)-8-tetradecenal and the like, that are intended to give odors reminiscent of the desired scent family or source. Listings of chemical compounds responsible for citrus and fruit scents can be found in a variety of reference books such as Common Fragrance and Flavor Materials—Preparation, Properties and Uses, 5^{th} edition, Wiley, 2006 herein incorporated by reference.

More specifically, “citrus scents” are those scents similar to those of the fruits of the genus Citrus L. from the family of the Rutaceae. Included within the term “citrus” are fruits of plants of the genus Fortunella, Poncirus, Microcitrus, Eremocitrus and crossings (hybrids) from plants of the aforementioned genera such as, for example, Citrus sinensis, Citrus reticulata, Citrus limon, Citrus grandis, Citrus medica, Citrus aurantifolia, Citrus aurantium, Citrus mitis, Citrus maxima, Citrus medica, Citrus glauca, Citrus australasica, Citrus sphaerocarpa, Citrus×paradisi, Citrus×aurantium, Citrus×limonia, Citrus×latifolia, Poncirus trifoliata, Citrus×macrophylla, Citrus×bergamia, Citrus×amblycarpa, Citrus×pennivesiculata, Citrus×ichangensis, Citrus limon×, Citrus paradisi, Citrus×hystrix, Citrus×latipes, Citrus×limon, Citrus×limetta, Citrus×Fortunella Hybrids, Citrus×limonia, Citrus×natsudaidai, Citrus×jambhiri, Citrus×depressa, Citrus×sunki, Citrus×limettioides, Citrus×nobilis and Citrus×junos and mixtures thereof.

Citrus scents which are particularly suitable for use within the scope of the present invention include, for example, orange, mandarin, tangerine, lemon, grapefruit, lime, kumquat, bergamot, tangelo, calamondin, clementine, gajanimma, iyokan, kabosu, kinnow, khasi pepeda, cedrate, limequat, mikan, natsumikan, orangelo, orangequat, oroblanco, pomelo, ponkan, rangpur, lemanderinsatsuma, shaddock, shekwasha, sudachi, sunkie, sweetie, tangor, ugli fruit and yuzu and mixtures thereof. Particularly well suited to the present invention are lemon, lime and orange scents.

The Citrus and fruit scents of this invention may contain a variety of compounds including, for example, hydrocarbons such as 3-carene; α-pinene; β-pinene; α-terpinene; γ-terpinene; p-cymene; bisabolene; camphene; caryophyllene; cedrene; farnesene; limonene; longifolene; myrcene; ocimene; valencene; (E,Z)-1,3,5-undecatriene; aliphatic alcohols such as hexanol; octanol; 3-octanol; 2,6-dimethylheptanol; 2-methylheptanol, 2-methyloctanol; (E)-2-hexenol; (E) and (Z)-3-hexenol; 1-octen-3-ol; mixture of 3,4,5,6,6-pentamethyl-3,4-hepten-2-ol and 3,5,6,6-tetramethyl-4-methyleneheptan-2-ol; (E,Z)-2,6-nonadienol; 3,7-dimethyl-7-methoxyoctan-2-ol; 9-decenol; 10-undecenol; 4-methyl-3-decen-5-ol; the aliphatic aldehydes and the 1,4-dioxacycloalken-2-ones thereof such as for example hexanal; heptanal; octanal; nonanal; decanal; undecanal; dodecanal; tridecanal; 2-methyloctanal; 2-methylnonanal; (E)-2-hexenal; (Z)-4-heptenal; 2,6-dimethyl-5-heptenal; 10-undecenal; (E)-4-decenal; 2-dodecenal; 2,6,10-trimethyl-5,9-undecadienal; heptanaldiethylacetal; 1,1-dimethoxy-2,2,5-trimethyl-4-hexene; the aliphatic ketones and the oximes thereof such as for example 2-heptanone; 2-octanone; 3-octanone; 2-nonanone; 5-methyl-3-heptanone; 5-methyl-3-heptanone oxime; 2,4,4,7-tetramethyl-6-octen-3-one; the aliphatic sulfur-containing compounds such as for example 3-methylthiohexanol; 3-methylthiohexyl acetate; 3-mercaptohexanol; 3-mercaptohexyl acetate; 3-mercaptohexyl butyrate; 3-acetylthiohexyl acetate; 1-menthene-8-thiol; the aliphatic nitriles such as for example 2-nonenenitrile; 2-tridecenenitrile; 2,12-tridecadienenitrile; 3,7-dimethyl-2,6-octadienenitrile; 3,7-dimethyl-6-octenenitrile; the aliphatic carboxylic acids and the esters thereof such as for example (E)- and (Z)-3-hexenyl formate; ethyl acetoacetate; isoamyl acetate; hexyl acetate; 3,5,5-trimethylhexyl acetate; 3-methyl-2-butenyl acetate; (E)-2-hexenyl acetate; (E)- and (Z)-3-hexenyl acetate; octyl acetate; 3-octyl acetate; 1-octen-3-yl acetate; ethyl butyrate; butyl butyrate, isoamyl butyrate; hexyl butyrate; (E)- and (Z)-3-hexenyl isobutyrate; hexyl crotonate; ethyl isovalerate; ethyl-2-methylpentanoate; ethyl hexanoate; allyl hexanoate; ethyl heptanoate; allyl heptanoate; ethyl octanoate; ethyl(E,Z)-2,4-decadienoate; methyl-2-octynoate; methyl-2-nonynoate; allyl 2-isoamyl oxyacetate; methyl-3,7-dimethyl-2,6-octadienoate; the acyclic terpene alcohols such as for example citronellol; geraniol; nerol; linalool; lavandulol; nerolidol; farnesol; tetrahydrolinalool; tetrahydrogeraniol; 2,6-dimethyl-7-octen-2-ol; 2,6-dimethyloctan-2-ol; 2-methyl-6-methylene-7-octen-2-ol; 2,6-dimethyl-5,7-octadien-2-ol; 2,6-dimethyl-3,5-octadien-2-ol; 3,7-dimethyl-4,6-octadien-3-ol; 3,7-dimethyl-1,5,7-octatrien-3-ol; 2,6-dimethyl-2,5,7-octatrien-1-ol; and the formates, acetates, propionates, isobutyrates, butyrates, isovalerates, pentanoates, hexanoates, crotonates, tiglinates, 3-methyl-2-butenoates thereof; the acyclic terpene aldehydes and ketones such as for example geranial; neral; cirtonellal; 7-hydroxy-3,7-dimethyloctanal; 7-methoxy-3,7-dimethyloctanal; 2,6,10-trimethyl-9-undecenal; geranylacetone; and the dimethyl and diethyl acetals of geranial, neral, 7-hydroxy-3,7-dimethyloctanal; the cyclic terpene alcohols such as for example menthol; isopulegol; alpha-terpineol; terpineol-4; menthan-8-ol; menthan-1-ol; menthan-7-ol; borneol; isoborneol; linalool oxide; nopol; cedrol; ambrinol; vetiverol; guaiol; and the formates, acetates, propionates, isobutyrates, butyrates, isovalerates, pentanoates, hexanoates, crotonates, tiglinates, 3-methyl-2-butenoates thereof; the cyclic terpene aldehydes and ketones such as for example menthone; isomenthone; 8-mercaptomenthan-3-one; carvone; camphor; fenchone; alpha-ionone; beta-ionone; alpha-n-methylionone; beta-n-methylionone; alpha-isomethylionone; beta-isomethylionone; alpha-iron; alpha-damascone; beta-damascone; beta-damascenone; delta-damascone; gamma-damascone; 1-(2,4,4-trimethyl-2-cyclo-hexen-1-yl)-2-buten-1-one; 1,3,4,6,7,8a-hexahydro-1 ,1,5,5-tetramethyl-2H-2,4-a-methanonaphthalen-8(5H)-one; nootkatone; dihydronootkatone; alpha-sinensal; beta-sinensal; the cyclic alcohols such as for example 4-tert-butylcyclohexanol; 3,3,5-trimethylcyclohexanol; 3-isocamphylcyclohexanol; 2,6,9-trimethyl-Z2,Z5,E9-cyclododecatrien-1-ol; 2-isobutyl-4-methyltetrahydro-2H-pyran-4-ol; the cycloaliphatic alcohols such as for example alpha-3,3-trimethylcyclohexylmethanol; 2-methyl-4-(2,2,3-trimethyl-3-cyclopent-1-yl)butanol; 2-methyl-4-(2,2,3-trimethyl-3-cyclopent-1-yl)-2-buten-1-ol; 2-ethyl-4-(2,2,3-trimethyl-3-cyclopent-1-yl)-2-buten-1-ol; 3-methyl-5-(2,2,3-trimethyl-3-cyclopent-1-yl)-pentan-2-ol; 3-methyl-5-(2,2,3-trimethyl-3-cyclopent-1-yl)-4-penten-2-ol; 3,3-dimethyl-5-(2,2,3-trimethyl-3-cyclopent-1-yl)-4-penten-2-ol; 1-(2,2,6-trimethylcyclohexyl)pentan-3-ol; 1-(2,2,6-trimethylcyclohexyl)-hexan-3-ol; the esters of cycloaliphatic carboxylic acids such as for example allyl-3-cyclohexylpropionate; ethyl-2-methyl propionate, ethyl-butanoate, allyl cyclohexyloxyacetate; methyl dihydrojasmonate; methyl jasmonate; methyl-2-hexyl-3-oxocyclopentanecarboxylate; ethyl-2-ethyl-6,6-dimethyl-2-cyclohexenecarboxylate; ethyl-2,3,6,6-tetramethyl-2-cyclohexenecarboxylate; ethyl-2-methyl-1,3-dioxolan-2-acetate; the aromatic hydrocarbons such as for example styrene and diphenylmethane; the araliphatic alcohols such as for example benzyl alcohol; 1-phenylethyl alcohol; 2-phenylethyl alcohol; 3-phenylpropanol; 2-phenylpropanol; 2-phenoxyethanol; 2,2-dimethyl-3-phenylpropanol; 2,2-dimethyl-3-(3-methylphenyl)propanol; 1,1-dimethyl-2-phenylethyl alcohol; 1,1-dimethyl-3-phenylpropanol; 1-ethyl-1-methyl-3-phenylpropanol; 2-methyl-5-phenylpentanol; 3-methyl-5-phenylpentanol; 3-phenyl-2-propen-1-ol; 4-methoxybenzyl alcohol; 1-(4-isopropylphenyl)ethanol; the esters of araliphatic alcohols and aliphatic carboxylic acids such as for example benzyl acetate; benzyl propionate; benzyl isobutyrate; benzyl isovalerate; 2-phenylethyl acetate; 2-phenylethyl propionate; 2-phenylethyl isobutyrate; 2-phenylethyl isovalerate; 1-phenylethyl acetate; alpha-trichloromethylbenzyl acetate; alpha,alpha-dimethylphenylethyl acetate; alpha,alpha-dimethyl phenylethyl butyrate; cinnamyl acetate; 2-phenoxyethyl isobutyrate; 4-methoxybenzyl acetate; the araliphatic ethers such as for example 2-phenylethyl methyl ether; 2-phenylethyl isoamyl ether; 2-phenylethyl-1-ethoxyethyl ether; phenylacetaldehyde dimethyl acetal; phenylacetaldehyde diethyl acetal; hydratropaldehyde dimethyl acetal; phenylacetaldehyde glycerol acetal; the aromatic and araliphatic aldehydes such as for example benzaldehyde; phenylacetaldehyde; 3-phenylpropanal; hydratropaldehyde; 4-methylbenzaldehyde; 4-methylphenylacetaldehyde; 3-(4-ethylphenyl)-2,2-dimethylpropanal; 2-methyl-3-(4-isopropylphenyl)propanal; 2-methyl-3-(4-tert-butylphenyl)propanal; 3-(4-tert-butylphenyl)propanal; cinnamaldehyde; alpha-butylcinnamaldehyde; alpha-amylcinnamaldehyde; alpha-hexylcinnamaldehyde; 3-methyl-5-phenylpentanal; 4-methoxybenzaldehyde; 4-hydroxy-3-methoxybenzaldehyde; 4-hydroxy-3-ethoxybenzaldehyde; 3,4-methylenedioxybenzaldehyde; 3,4-dimethoxybenzaldehyde; 2-methyl-3-(4-methoxyphenyl)propanal; 2-methyl-3-(4-methylenedioxyphenyl)propanal; the aromatic and araliphatic ketones such as for example acetophenone; 4-methylacetophenone; 4-methoxyacetophenone; 4-tert-butyl-2,6-dimethylacetophenone; 4-phenyl-2-butanone; 4-(4-hydroxyphenyl)-2-butanone; 1-(2-naphthalenyl)ethanone; benzophenone; the aromatic and araliphatic carboxylic acids and the esters thereof such as for example benzoic acid; phenylacetic acid; methyl benzoate; ethyl benzoate; hexyl benzoate; benzyl benzoate; methyl phenylacetate; ethyl phenylacetate; geranyl phenylacetate; phenylethyl phenylacetate; methyl cinnamate; ethyl cinnamate; benzyl cinnamate; phenylethyl cinnamate; cinnamyl cinnamate; allyl phenoxyacetate; methyl salicylate; isoamyl salicylate; hexyl salicylate; cyclohexyl salicylate; cis-3-hexenyl salicylate; benzyl salicylate; phenylethyl salicylate; methyl-2,4-dihydroxy-3,6-dimethylbenzoate; ethyl-3-phenyl glycidate; ethyl-3-methyl-3-phenyl glycidate; the nitrogen-containing aromatic compounds such as for example 2,4,6-trinitro-1,3-dimethyl-5-tert-butyl benzene; 3,5-dinitro-2,6-dimethyl-4-tert-butylacetophenone; cinnamonitrile; 5-phenyl-3-methyl-2-pentenenitrile; 5-phenyl-3-methylpentanenitrile; methyl anthranilate; methyl N-methylanthranilate; Schiff bases of methyl anthranilate with 7-hydroxy-3,7-dimethyloctanal; 2-methyl-3-(4-tert-butylphenyl)propanal or 2,4-dimethyl-3-cyclohexenecarbaldehyde; 6-isopropylquinoline; 6-isobutylquinoline; 6-sec-butylquinoline; indole; skatole; 2-methoxy-3-isopropylpyrazine; 2-isobutyl-3-methoxypyrazine; the phenols, phenyl ethers and phenyl esters such as for example estragole; anethole; eugenole; eugenyl methyl ether; isoeugenole; isoeugenyl methyl ether; thymole; carvacrol; diphenyl ether; beta-naphthyl methyl ether; beta-naphthyl ethyl ether; beta-naphthyl isobutyl ether; 1,4-dimethoxybenzene; eugenyl acetate; 2-methoxy-4-methylphenol; 2-ethoxy-5-(1-propenyl)phenol; p-cresyl phenylacetate; the heterocyclic compounds such as for example 2,5-dimethyl-4-hydroxy-2H-furan-3-one; 2-ethyl-4-hydroxy-5-methyl-2H-furan-3-one; 3-hydroxy-2-methyl-4H-pyran-4-one; 2-ethyl-3-hydroxy-4H-pyran-4-one; the lactones such as for example 1,4-octanolide; 3-methyl-1,4-octanolide; 1,4-nonanolide; 1,4-decanolide; 8-decen-1,4-olide; 1,4-undecanolide; 1,4-dodecanolide; 1,5-decanolide; 1,5-dodecanolide; 1,15-pentadecanolide; cis and trans-11-pentadecen-1,15-olide; cis and trans-12-pentadecen-1,15-olide; 1,16-hexadecanolide; 9-hexadecen-1,16-olide; 10-oxa-1,16-hexadecanolide; 11-oxa-1,16-hexadecanolide; 12-oxa-1,16-hexadecanolide; ethylene-1,12-dodecanedioate; ethylene-1,13-tridecanedioate; coumarin; 2,3-dihydrocoumarin; octahydrocoumarin.

Additional aromatic substances which may be contained within the scents of this invention include acetaldehyde, acetylmethylcarbinol, acetophenone, allyl caproate, alpha-ionone, beta-ionone, anisaldehyde, anisyl acetate, anisyl formate, benzaldehyde, benzothiazole, benzyl acetate, benzyl acetate, benzyl alcohol, benzyl benzoate, beta-ionone, butyl butyrate, butyric acid, butyl caproate, butylidene phthalide, capric acid, caproic acid, caprylic acid, carvone, camphene caryophyllene, cineol, cinnamyl acetate, citral, citronellol, citronellal, citronellyl acetate, cyclohexyl acetate, cymol, damascone, decalactone, diacetyl, dihydrocoumarin, dimethyl anthranilate, dimethyl anthranilate, dodecalactone, acetic acid, ethoxyethyl acetate, ethyl acetate, ethylbutyric acid, ethyl butyrate, ethyl caprinate, ethyl caproate, ethyl crotonate, ethyl formate, ethyl furaneol, ethyl guajacol, ethyl isobutyrate, ethyl isovalerate, ethyl lactate, ethyl lactate, ethyl maltol, ethyl methyl butyrate, ethyl propionate, eucalyptol, eugenol, ethyl heptylate, Frambinone®, gamma-decalactone, geraniol, geranyl acetate, geranyl acetate, grapefruit aldehyde, hedione, heliotropin, 2-heptanone, 3-heptanone, 4-heptanone, trans-2-heptenal, cis-4-heptenal, trans-2-hexenal, cis-3-hexenol, trans-2-hexenoic acid, trans-3-hexenoic acid, cis-2-hexenyl acetate, cis-3-hexenyl acetate, cis-3-hexenyl caproate, trans-2-hexenyl caproate, cis-3-hexenyl formate, cis-2-hexyl acetate, cis-3-hexyl acetate, trans-2-hexyl acetate, cis-3-hexyl formate, para-hydroxy benzyl acetone, isoamyl alcohol, isoamyl isovalerate, isobutyl butyrate, isobutyraldehyde, isoeugenol methyl ether, isopropylmethylthiazole, lauric acid, levulinic acid, linalool, linalool oxide, linalyl acetate, maltol, menthol, menthofuran, methyl anthranilate, methylbutanol, methylbutyric acid, 2-methylbutyl acetate, methyl caproate, methyl cinnamate, 5-methyl furfural, 3,2,2-methyl cyclopentenolone, 6,5,2-methyl heptenone, methyl dihydrojasmonate, methyl jasmonate, 2-methyl methyl butyrate, 2-methyl-2-pentenoic acid, methylthiobutyrate, 3,1-methylthiohexanol, 3-methylthiohexyl acetate, nerol, neryl acetate, trans,trans,2,4-nonadienal, 2,4-nonadienol, 2,6-nonadienol, 2,4-nonadienol, nootkatone, delta-octalactone, gamma-octalactone, 2-octanol, 3-octanol, 1,3-octenol, 1-octyl acetate, 3-octyl acetate, palmitic acid, paraldehyde, phellandrene, pentanedione, phenylethyl acetate, phenylethyl alcohol, phenylethyl alcohol, phenylethyl isovalerate, piperonal, propionaldehyde, propionic acid, propyl butyrate, pulegone, pulegol, sinensal, sulfurol, terpinene, terpineol, terpinolene, 8,3-thiomenthanone, 4,4,2-thiomethyl pentanone, thymol, delta-undecalactone, gamma-undecalactone, valencene, valeric acid, vanillin, acetoin, ethyl vanillin, ethyl vanillin isobutyrate (=3-ethoxy-4-isobutyryloxybenzaldehyde), Furaneol® (2,5-dimethyl-4-hydroxy-3(2H)-furanone) and the derivatives thereof (in this case preferably homofuraneol (=2-ethyl-4-hydroxy-5-methyl-3(2H)-furanone), homofuronol (=2-ethyl-5-methyl-4-hydroxy-3(2H)-furanone and 5-ethyl-2-methyl-4-hydroxy-3(2H)-furanone), maltol and maltol derivatives (in this case preferably ethyl maltol), coumarin and coumarin derivatives, gamma-lactones (in this case preferably gamma-undecalactone, gamma-nonalactone, gamma-decalactone), delta-lactones (in this case preferably 4-methyl delta decalactone, massoia lactone, delta decalactone, tuberose lactone), methyl sorbate, divanillin, 4-hydroxy-2(or 5)-ethyl-5(or 2)-methyl-3(2H)furanone, 2-hydroxy-3-methyl-2-cyclopentenone, 3-hydroxy-4,5-dimethyl-2(5H)-furanone, acetic acid isoamyl ester, butyric acid ethyl ester, butyric acid-n-butyl ester, butyric acid isoamyl ester, 3-methylbutyric acid ethyl ester, n-hexanoic acid ethyl ester, n-hexanoic acid allyl ester, n-hexanoic acid-n-butyl ester, n-octanoic acid ethyl ester, ethyl-3-methyl-3-phenyl glycidate, ethyl-2-trans-4-cis-decadienoate, 4-(p-hydroxyphenyl)-2-butanone, 1,1-dimethoxy-2,2,5-trimethyl-4-hexane, 2,6-dimethyl-5-hepten-1-al and phenylacetaldehyde, 2-methyl-3-(methylthio)furan, 2-methyl-3-furanthiol, bis(2-methyl-3-furyl)disulfide, furfuryl mercaptan, methional, 2-acetyl-2-thiazoline, 3-mercapto-2-pentanone, 2,5-dimethyl-3-furanthiol, 2,4,5-trimethylthiazole, 2-acetylthiazole, 2,4-dimethyl-5-ethylthiazole, mercapto-3-methyl-1-butanol, 2-acetyl-1-pyrroline, 2-methyl-3-ethylpyrazine, 2-ethyl-3,5-dimethylpyrazine, 2-ethyl-3,6-dimethylpyrazine, 2,3-diethyl-5-methylpyrazine, 3-isopropyl-2-methoxypyrazine, 3-isobutyl-2-methoxypyrazine, 2-acetylpyrazine, 2-pentylpyridine, (E,E)-2,4-decadienal, (E,E)-2,4-nonadienal, (E)-2-octenal, (E)-2-nonenal, 2-undecenal, 12-methyltridecanal, 1-penten-3-one, 2,3-butanedione, 4-hydroxy-2,5-dimethyl-3(2H)-furanone, guajacol, 3-hydroxy-4,5-dimethyl-2(5H)-furanone, 3-hydroxy-4-methyl-5-ethyl-2(5H)-furanone, dimethyl sulfide, trimethylamine, cinnamaldehyde, cinnamyl alcohol, methyl salicylate, isopulegol and further stereoisomers, enantiomers, positional isomers, diastereomers, cis/trans-isomers or epimers and mixtures thereof.

Other suitable fresh category fragrances include, but are not limited to, those comprising alcohols or combinations of alcohols, such as 2,4-dimethyl-3-cyclohexene-1-methanol (Floralol), 2,4-dimethyl cyclohexane methanol (Dihydro floralol), 5,6-dimethyl-1-methylethenylbicyclo[2.2.1]hept-5-ene-2-methanol (Arbozol), 2,4,6-trimethyl-3-cyclohexene-1-methanol (Isocyclo geraniol), 4-(1-methylethyl)cyclohexanemethanol (Mayol), α-3,3-trimethyl-2-norborane methanol, 1,1-dimethyl-1-(4-methylcyclohex-3-enyl)methanol, ethanol, 2-phenylethanol, 2-(o-methylphenyl)-ethanol, 2-(m-methylphenyl)ethanol, 2-(p-methylphenyl)ethanol, 6,6-dimethylbicyclo-[3.1.1]hept-2-ene-2-ethanol (nopol), 2-(4-methylphenoxy)ethanol, 3,3-dimethyl-D ²-b-norbornane ethanol, 2-methyl-2-cyclohexylethanol, 1-(4-isopropylcyclohexyl)-ethanol, 1-phenylethanol, 1,1-dimethyl-2-phenylethanol, 1,1-dimethyl-2-(4-methyl-phenyl)ethanol, 2,2-dimethyl-3-(3-methylphenyl)propan-1-ol (Majantol), 2-methyl-3-phenylpropanol, 3-phenyl-2-propen-1-ol (cinnamyl alcohol), 2-methyl-3-phenyl-2-propen-1-ol (methylcinnamyl alcohol), a-n-pentyl-3-phenyl-2-propen-1-ol (a-amyl-cinnamyl alcohol), ethyl-3-hydroxy-3-phenyl propionate, 2-(4-methylphenyl)-2-propanol, 3-(4-methylcyclohex-3-ene)butanol, 2-methyl-4-(2,2,3-trimethyl-3-cyclopenten-1-yl)butanol, 2-ethyl-4-(2,2,3-trimethyl-cyclopent-3-enyl)-2-buten-1-ol, 3-methyl-2-buten-1-ol, 2-methyl-4-(2,2,3-trimethyl-3-cyclopenten-1-yl)-2-buten-1-ol, 3-hydroxy-2-butanone, ethyl 3-hydroxybutyrate, 4-phenyl-3-buten-2-ol, 2-methyl-4-phenylbutan-2-ol, 4-(4-hydroxyphenyl)butan-2-one, 4-(4-hydroxy-3-methoxyphenyl)butan-2-one, pentanol, cis-3-pentenol, 3-methyl-pentanol, 3-methyl-3-penten-1-ol, 2-methyl-4-phenylpentanol (Pamplefleur), 3-methyl-5-phenylpentanol (Phenoxanol), 2-methyl-5-phenylpentanol, 2-methyl-5-(2,3-dimethyltricyclo[2.2.1.0(2,6)]hept-3-yl)-2-penten-1-ol (santalol), 4-methyl-1-phenyl-2-pentanol, (1-methyl-bicyclo[2.1.1]hepten-2-yl)-2-methylpent-1-en-3-ol, 3-methyl-1-phenylpentan-3-ol, 1,2-dimethyl-3-(1-methylethenyl)cyclopentan-1-ol, 2-isopropyl-5-methyl-2-hexenol, cis-3-hexen-1-ol, trans-2-hexen-1-ol, 2-isoproenyl-4-methyl-4-hexen-1-ol (Lavandulol), 2-ethyl-2-prenyl-3-hexenol, 1-hydroxymethyl-4-iso-propenyl-1-cyclohexene (Dihydrocuminyl alcohol), 1-methyl-4-isopropenylcyclohex-6-en-2-ol (carvenol), 6-methyl-3-isopropenylcyclohexan-1-ol, 1-methyl-4-iso-propenylcyclohexan-3-ol, 4-isopropyl-1-methylcyclohexan-3-ol, 4-tert-butylcyclo-hexanol, 2-tert-butylcyclohexanol, 2-tert-butyl-4-methylcyclohexanol, 4-isopropyl-cyclohexanol, 4-methyl-1-(1-methylethyl)-3-cyclohexen-1-ol, 2-(5,6,6-trimethyl-2-norbornyl)cyclohexanol, isobornylcyclohexanol, 3,3,5-trimethylcyclohexanol, 1-methyl-4-isopropylcyclohexan-3-ol, 1,2-dimethyl-3-(1-methylethyl)cyclohexan-1-ol, heptanol, 2,4-dimethylheptan-1-ol, 2,4-dimethyl-2,6-heptandienol, 6,6-dimethyl-2-oxymethylbicyclo[3.1.1]hept-2-ene(myrtenol), 4-methyl-2,4-heptadien-1-ol, 3,4,5,6,6-pentamethyl-2-heptanol, 3,6-dimethyl-3-vinyl-5-hepten-2-ol, 6,6-dimethyl-3-hydroxy-2-methylenebicyclo[3.1.1]heptane, 1,7,7-trimethylbicyclo[2.2.1]heptan-2-ol, 2,6-dimethylheptan-2-ol, 2,6,6-trimethylbicyclo[1.3.3]heptan-2-ol, octanol, 2-octenol, 2-methyloctan-2-ol, 2-methyl-6-methylene-7-octen-2-ol (myrcenol), 7-methyloctan-1-ol, 3,7-dimethyl-6-octenol, 3,7-dimethyl-7-octenol, 3,7-dimethyl-6-octen-1-ol (citronellol), 3,7-dimethyl-2,6-octadien-1-ol (geraniol), 3,7-dimethyl-2,6-octadien-1-ol (nerol), 3,7-dimethyl-1,6-octadien-3-ol (linalool), 3,7-dimethyloctan-1-ol (pelagrol), 3,7-dimethyloctan-3-ol (tetrahydrolinalool), 2,4-octadien-1-ol, 3,7-dimethyl-6-octen-3-ol, 2,6-dimethyl-7-octen-2-ol, 2,6-dimethyl-5,7-octadien-2-ol, 4,7-dimethyl-4-vinyl-6-octen-3-ol, 3-methyloctan-3-ol, 2,6-dimethyloctan-2-ol, 2,6-dimethyloctan-3-ol, 3,6-dimethyloctan-3-ol, 2,6-dimethyl-7-octen-2-ol, 2,6-dimethyl-3,5-octadien-2-ol (muguol), 3-methyl-1-octen-3-ol, 7-hydroxy-3,7-dimethyloctanal, 3-nonanol, 2,6-nonadien-1-ol, cis-6-nonen-1-ol, 6,8-dimethylnonan-2-ol, 3-(hydroxymethyl)-2-nonanone, 2-nonen-1-ol, 2,4-nonadien-1-ol, 3,7-dimethyl-1,6-nonadien-3-ol, decanol, 9-decenol, 2-benzyl-M-dioxa-5-ol, 2-decen-1-ol, 2,4-decadien-1-ol, 4-methyl-3-decen-5-ol, 3,7,9-trimethyl-1,6-decadien-3-ol (isobutyl linalool), undecanol, 2-undecen-1-ol, 10-undecen-1-ol, 2-dodecen-1-ol, 2,4-dodecadien-1-ol, 2,7,11-trimethyl-2,6,10-dodecatrien-1-ol (farnesol), 3,7,11-trimethyl-1,6,10,-dodecatrien-3-ol, 3,7,11,15-tetramethylhexadec-2-en-1-ol (phytol), 3,7,11,15-tetramethylhexadec-1-en-3-ol (iso phytol), benzyl alcohol, p-methoxy benzyl alcohol (anisyl alcohol), para-cymen-7-ol (cuminyl alcohol), 4-methyl benzyl alcohol, 3,4-methylenedioxy benzyl alcohol, cis-3-hexenyl salicylate, n-pentyl salicylate, 2-phenylethyl salicylate, n-hexyl salicylate, 2-methyl-5-isopropylphenol, 4-ethyl-2-methoxyphenol, 4-allyl-2-methoxyphenol (eugenol), 2-methoxy-4-(1-propenyl)phenol (isoeugenol), 4-allyl-2,6-dimethoxyphenol, 4-tert-butyl phenol, 2-ethoxy-4-methylphenol, 2-methyl-4-vinylphenol, 2-isopropyl-5-methylphenol (thymol), pentyl-ortho-hydroxy benzoate, ethyl 2-hydroxy-benzoate, methyl 2,4-dihydroxy-3,6-dimethylbenzoate, 3-hydroxy-5-methoxy-1-methylbenzene, 2-tert-butyl-4-methyl-1-hydroxybenzene, 1-ethoxy-2-hydroxy-4-propenyl benzene, 4-hydroxytoluene, 4-hydroxy-3-methoxybenzaldehyde, 2-ethoxy-4-hydroxybenzaldehyde, decahydro-2-naphthol, 2,5,5-trimethyl-octahydro-2-naphthol, 1,3,3-trimethyl-2-norbornanol (fenchol), 3a,4,5,6,7,7a-hexahydro-2,4-dimethyl-4,7-methano-1H-inden-5-ol, 3a,4,5,6,7,7a-hexahydro-3,4-dimethyl-4,7-methano-1H-inden-5-ol, 2-methyl-2-vinyl-5-(1-hydroxy-1-methylethyl)tetrahydrofuran, b-caryophyllene alcohol, and mixtures thereof.

Preferred alcohols for the Fresh family scents are 3,7-dimethyl-1,6-octadien-3-ol (linalool), 2,6-dimethyl-7-octen-2-ol (dihydromyrcenol) 4-(1-methylethyl)cyclohexanemethanol (mayol), 2,4-dimethyl-3-cyclohexen-1-ylmethanol (floralol), 2,4-dimethylcyclohex-1-ylmethanol (dihydrofloralol), 2,4,6-trimethyl-3-cyclohexen-1-ylmethanol (isocyclogeraniol), 2-phenylethanol, 1-(4-isopropylcyclohexyl)ethanol (mugetanol), 2-(o-methylphenyl)ethanol (ortho-hawthanol), 2-(m-methylphenyl)ethanol (meta-hawthanol), 2-(p-methylphenyl)-ethanol (para-hawthanol), 2,2-dimethyl-3-(3-methylphenyl)propan-1-ol (majantol), 3-phenyl-2-propen-1-ol (cinnamic alcohol), 2-methyl-4-(2,2,3-trimethyl-3-cyclopenten-1-yl)-2-buten-1-ol (santalaire), 3-methyl-5-phenylpentan-1-ol (phenoxanol), 3-methyl-5-(2,2,3-trimethyl-3-cyclopenten-1-yl)-4-penten-2-ol(ebanol), 2-methyl-4-phenylpentan-1-ol (pamplefleur), cis-3-hexen-1-ol, 3,7-dimethyl-6-octen-1-ol (citronellol), 3,7-dimethyl-2,6-octadien-1-ol (geraniol, nerol or mixtures thereof), 7-methoxy-3,7-dimethyloctan-2-ol (osyrol), 6,8-dimethylnonan-2-ol, cis-6-nonen-1-ol, 2,6-nonadien-1-ol, 4-methyl-3-decen-5-ol(undecavertol), benzyl alcohol, 2-methoxy-4-(1-propenyl)phenol (isoeugenol), 2-methoxy-4-(2-propenyl)phenol (eugenol), 4-hydroxy-3-methoxybenzaldehyde (vanillin), and mixtures thereof. More preferably 3,7-dimethyl-1,6-octadien-3-ol (linalool), 2,6-dimethyl-7-octen-2-ol (dihydromyrcenol), and mixtures thereof.

The fragrance is present within the paper towel sheet or on the surface of the sheet, such that when the sheet is separated from the roll or stack of sheets and removed to a location isolated from the roll or stack of sheets, the resulting cleaning-related scent is present and noticeable to the user. Advantageously, the fragrance is applied directly to the sheet during manufacturing, such as by printing, spraying and the like, and not to the core or packaging of the product, so as to insure that the desired scent is present at the point of use (not just at the point of dispensing) and that the fragrance is present in a sufficient amount so that it can preferably transfer to the target surface to reinforce the perception of germ removal effectiveness. The amount of fragrance applied to the sheet will vary depending upon the particular cleaning-related scent desired, since different scents have different olfactory sensitivity levels. In general, the add-on amount of neat fragrance, based on the dry weight of the sheet, will be from about 0.01 to about 2 dry weight percent or greater, more specifically from about 0.02 to about 1 dry weight percent, and still more specifically from about 0.03 to about 0.8 dry weight percent. As used herein, “neat” fragrance refers to the amount of fragrance minus any fixatives or diluents which may be present in the fragrance.

The paper towel sheets of this invention also include a visual functional indicia that implies germ removal effectiveness. Such visual indicia can be imparted to the sheets by printing, for example. The visual functional indicia is characterized by its design (pattern) and by its color and conveys a functional message to the consumer that the product is effective for cleaning and removing germs, rather than conveying an aesthetic message, as is the case with current commercially available paper towel products. For purposes herein, the design is devoid of multi-cellular animate objects (living objects or objects that were once part of a living object). Animate objects include people and animals, flowers, trees, fruits, vegetables and the like. Preferably, the design of the visual functional indicia is further devoid of representing man-made inanimate objects such as houses, buildings, cars, doors, windows, cooking utensils, dishes, cups, bottles, vases, appliances, furniture and the like. The designs are still preferably devoid of any additional ornament. The term “ornament” is intended to describe a detail that is added to the design for the sole purpose of beautifying the appearance of the design. For example, the design is preferably devoid of a border (a unique ornamental strip or design around the edge or perimeter of the individual sheets).

In one embodiment, the visual indicia is a design that has no discernable pattern and covers essentially 100 percent of the surface of the sheet. In another embodiment, the visual indicia is a design having a geometric pattern, either as a repeating unit or as a non-repeating pattern, across the length and width of the sheet.

In another embodiment of the present invention, the design of the visual indicia may represent living organisms from the biological kingdom Monera. The Monera kingdom consists of single-celled organisms without a cell nucleus. This kingdom includes germs, bacteria and algae. These living, single-celled organisms may be spherical, spiral or rod-shaped and may appear singly or in chains. The organisms depicted may be caricatures of germs, wherein said germs are depicted as having various body parts including arms, legs, eyes, mouth, nose, ears, etc., but wherein the image clearly conveys that it is a bacterium, algae, virus or other germ-related object or organism.

In addition to the design, the functional indicia of the present invention can be defined by its colors. Studies have shown that people are influenced by color in that color impacts mood, emotion, memory and attention. From the study of chromodynamics, it is known that actual physiological changes take place in human beings when they are exposed to certain colors. Colors can stimulate, excite, depress, tranquilize, increase appetite and create a feeling of warmth or coolness. Within the context of the present invention, it has been discovered that the “cool” colors visually communicate germ control better than “warm” colors. The differentiation between “cool” colors and “warm” colors is well understood to those skilled in the art. In general, the colors red, orange, yellow are considered to be warm, whereas blue, cyan and adjacent colors on the standard color wheel are considered to be cool. The term “cool”, such as a cool color or triad, refers to colors that can be associated with water, such as blues, greens and violets. Generally, colors that are more green than yellow and more blue than red are cooler colors.

A pictorial way of representing colors is to use a “Color Wheel”. The Color Wheel is well understood by those skilled in the art and is a conventional means of arranging the primary colors (blue, red, and yellow), their principal mixtures or secondary colors (orange, green, and violet), and other principal mixtures or hues, so as to demonstrate their sequential relationship. Color as used herein refers to the placement on the Color Wheel. As used herein, “hue” refers to the actual color with its qualities such as its yellowness and blueness. “Chroma” or “intensity”, as used herein, refers to the purity of a color, or its freedom from white or gray and defines the intensity of distinctive hue and saturation of a color. The term “shade” is a relative term meaning darker in color, but otherwise of similar hue and relative chroma. The term “tint” is a relative term meaning lighter color but otherwise similar hue and relative chroma.

The more intense a color, the more of the pure color is added. “Related” and “analogous” colors are used interchangeably and, as used herein, refer to colors that are located one next to the other on the Color Wheel, such as yellow and orange. Complementary colors are colors that are opposite to each other on the Color Wheel. An example of complementary colors are red and green.

L*a*b* and LCH are both descriptive color systems that are closely related. L*a*b is a color system that was developed as a method of calculating all the colors that are viewable by the human eye. L*a*b color is a mathematical model defined in terms of luminosity and brightness, as well as two axes: green to magenta and blue to yellows. In L*a*b* color space, color can be expressed in terms of Luminosity (L*), an a*-chromaticity layer (i.e., red-green balance), and a b*-chromaticity layer (i.e., blue-yellow balance). The relationship between these various components of color can be graphically presented as a circle where chroma (i.e., colorfulness) is defined as the radius, the center of the circle is neutral, and colorfulness increases moving outward along the radius from the center. In L*a*b* color space, hue is expressed as an angle equal to the arc tangent of a*/b*. L*a*b* color space may also be presented as a sphere to illustrate the opponent nature of L*a*b space. The L*a*b* and LCH color models incorporate all the colors in the CMYK spectrum and the RGB color spectrum.

The term “hue” refers to the angle of the color when mapped into color space as shown on the Color Wheel. Hue ranges from 0-360 degrees. In L*a*b* and LCH color space, hue is expressed as an angle equal to the arc tangent of a*/b*. In particular for the present invention, the colors or hues of the visual functional indicia are selected from the set of “cool colors”. More specifically, the colors of the visual functional indicia are selected from colors having a hue angle, as determined by the Color Wheel, of from about 60° to about 300°, more specifically from about 90° to about 270° and more specifically from about 120° to about 240°. In addition, the visual functional indicia may have a chroma value of from about 0 to about 100, more specifically from about 10 to about 90 and still more specifically from about 20 to about 80. The term “color family” refers to colors within a hue range of about 8°.

In one embodiment the color of the visual functional indicia is monochromatic. By monochromatic, it is meant all one hue. The indicia however may have a monochromatic color scheme wherein variations in lightness, saturation or chroma of the single hue may be present. In the monochromatic color scheme the primary hue may be integrated with neutral colors. By neutral is meant shades of white, black, gray, or beige. Monochromatic color schemes are found to produce a soothing effect especially when the cool colors are used.

In another embodiment, the colors used for the functional indicia are selected from the set of analogous colors. The term “analogous” color as used herein refers to colors with a hue angle difference of less than 60°, such as about less than 40°. The various hues within the analogous color set may have varying chroma depending upon the desired effect. In a specific embodiment, the analogous color scheme is selected from different hues within the same color family wherein the hues are selected such that the difference in hue angle between all the colors comprising the indicia is less than about 8°.

The sheets of the products of the present invention may optionally comprise a brand name or trademark. For purposes of the present invention, a trademark or brand name, if present, is not considered as part of the functional indicia. As such, the brand names and trademarks may comprise warm colors.

The products of this invention are shipped, sold, and stored dry. For purposes herein, “dry” means that the paper towel sheets contain no moisture other than that imparted by equilibrium with ambient relevant humidity conditions. In general, the moisture content of the sheets of the present invention at 50% relative humidity and 25° C. (standard TAPPI conditions) will range from about 0 to about 20 weight percent, more specifically from about 1 to about 15 weight percent, more specifically from about 1 to about 12 weight percent, and still more specifically from about 1 to about 8 weight percent. The moisture content is calculated as the difference between the “as-is” basis weight and bone dry basis weight, divided by the bone dry basis weight, expressed as a percent.

Suitable paper towel sheets include, without limitation, cellulosic sheets produced by throughdrying, whether creped or uncreped, which are well known in the art. Such sheets have the proper pore size/distribution to entrap germs when wiped across a hard surface. By way of non-limiting examples, such paper towel sheets can be made in accordance with the methods disclosed in U.S. Pat. Nos. 3,879,257 A; 7,642,258 B2; 5,989,682 A; 5,672,248 A; 6,808,790 B2; or 6,423,180 B1, all of which are herein incorporated by reference.

As the products of the present invention are intended to preferably be used wet, either due to the direct application of water or removal of moist contaminants on the hard surface, an important feature of the paper towel sheets is that they have an acceptable level of wet strength. “Wet strength”, as used herein, refers to the wet tensile strength in the weakest direction of the sheet. That is, the wet strength will refer to the wet tensile strength of the sheet measured in the direction of the sheet having the lowest dry tensile strength. For most paper towel products, this will be the cross-machine direction (CD) of the sheet. The CD wet tensile strength of the products of the present invention can be from about 500 to about 1200 grams or more per 3 inches of sample width. Furthermore, since the products of the present invention are intended to be used for cleaning, they need to have a minimum level of durability in the wet state. Durability in the wet state can be measured by the wet tensile energy absorbed (TEA), with the minimum wet TEA defined as the wet TEA taken in the direction of the weakest wet tensile strength. Again, for most paper towel products, this will be the tensile strength as taken in the cross-machine direction. The wet CD TEA of the products of the present invention can be about 4 g-cm/cm² or greater, more specifically from about 4 to about 20 g-cm/cm², more specifically from about 5 to about 15 g-cm/cm². In one embodiment, the wet CD TEA can be about 8 g-cm/cm².

The products of the present invention have the capacity to remove germs from surfaces without the presence of an effective amount of an antimicrobial agent. Notably, the paper towel sheets of the products of this invention do not contain an effective amount of an antimicrobial agent, such as non-natural, synthetic antimicrobial agents. The term “effective amount” means that the amount of the antimicrobial agent transferred to a non-porous surface is sufficient to cause a 4 log or greater reduction of viable bacteria on the surface. Examples of synthetic antimicrobial agents are those recognized as active ingredients in antimicrobial pesticides by the Environmental Protection Agency and include the standard quaternary ammonium disinfecting agents such as aliphatic and aromatic alkyl quaternaries such as n-alkyl Dimethyl Benzyl Ammonium Chlorides, n-Didecyl, Dimethyl Ammonium Chloride and n-Alkyl Dimethyl Ethylbenzyl Ammonium Chlorides. The sheets may, however, contain amounts of standard paper making additives, such as cationic wet strength agents, dry strength agents and quaternary ammonium debonders, which may demonstrate some antimicrobial activity, but are not present in an amount sufficient to be effective at killing germs on the surface being wiped.

Optionally, the sheets of the products of this invention can contain a cationic charge agent, such as aluminum chlorohydrate, which works by electrostatic means to attract and capture bacteria. In a specific embodiment of the present invention, the sheets of the products of this invention have the ability to not only “lift” or remove 99% or greater of the bacteria from a non-porous surface, but also thereafter “trap” or retain 99% or greater of the bacteria removed from the surface with in the sheet.

In addition, the products of this invention can have a unique size to distinguish themselves from conventional paper towel products on the retailer shelf. More specifically, if the product of this invention provides sheets in a rolled format, the width of the roll is preferably selected such that the roll width (the roll height as measured standing on end) is visually distinct from the roll width most commonly used for consumer paper towels in the region where the product is sold. More specifically, the roll width can either be about 10 or more percent greater than that of the most commonly found width, rounded to the nearest inch, or about 10 or more percent less than that of the most commonly found width, rounded to the nearest inch. Still more specifically, the roll width can either be about 15 or more percent greater than that of the most commonly found width, rounded to the nearest inch, or about 15 or more percent less than that of the most commonly found width, rounded to the nearest inch. Still more specifically, the roll width can either be from about 15 to about 50 percent greater than that of the most commonly found width, rounded to the nearest inch, or from about 15 to about 50 percent less than that of the most commonly found width, rounded to the nearest inch. By way of example, in North America where the primary roll width is 11 inches, on the larger side, the roll width can be from about 11 to about 17 inches, more specifically from about 12 to about 16 inches. Alternatively, on the smaller side, the roll width can be from about 6 to about 11 inches, more specifically from about 8 to about 10 inches. A variety of means known in the art may be employed to alter the roll width. Most commonly, however, the roll width will be altered by changing the individual sheet width during manufacturing/converting.

Optionally, the products of this invention may also include special packaging in order to highlight the germ-removal capabilities. Similarly to the visual functional indicia that can be imparted to the individual sheets, the packaging can also contain similar or the same visual functional indicia. In addition, the packaging, such as a poly wrapper commonly used for packaging paper towels, can contain a message that the sheets of the product remove 99 or greater percent of bacteria or germs when used to wipe hard surfaces.

In the interests of brevity and conciseness, any ranges of values set forth in this specification contemplate all values within the range and are to be construed as written description support for claims reciting any sub-ranges having endpoints which are whole numbers or otherwise of like numerical values within the specified range in question. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5. Similarly, a disclosure in this specification of a range from 0.1 to 0.5 shall be considered to support claims to any of the following ranges: 0.1-0.5; 0.1-0.4; 0.1-0.3; 0.1-0.2; 0.2-0.5; 0.2-0.4; 0.2-0.3; 0.3-0.5; 0.3-0.4; and 0.4-0.5. In addition, any values prefaced by the word “about” are to be construed as written description support for the value itself. By way of example, a range of “from about 1 to about 5” is to be interpreted as also disclosing and providing support for a range of “from 1 to 5”, “from 1 to about 5” and “from about 1 to 5”.

### Test Methods

### Dry Tensile Testing

As used herein, the “machine direction (MD) tensile strength” represents the peak load per sample width when a sample is pulled to rupture in the machine direction. In comparison, the cross-machine direction (CD) tensile strength represents the peak load per sample width when a sample is pulled to rupture in the cross-machine direction. Unless specified otherwise, tensile strengths are dry tensile strengths.

Samples for tensile strength testing are prepared by cutting a 3 inches (76.2 mm) wide×5 inches (127 mm) long strip in either the machine direction (MD) or cross-machine direction (CD) orientation using a JDC Precision Sample Cutter (Thwing-Albert Instrument Company, Philadelphia, Pa., Model No. JDC3-10, Ser. No. 37333). The instrument used for measuring tensile strengths is an MTS Systems Sintech 11S, Serial No. 6233 or equivalent. The data acquisition software is MTS TestWorks® for Windows Ver. 3.10 or current version 4.07B (MTS Systems Corp., Research Triangle Park, N.C.). The load cell is selected from either a 50 Newton or 100 Newton maximum, depending on the strength of the sample being tested, such that the majority of peak load values fall between 10-90 percent of the load cell's full scale value. The gauge length between jaws is 4+/−0.04 inches (101.6+/−mm). The jaws are operated using pneumatic action and are rubber coated. The minimum grip face width is 3 inches (76.2 mm), and the approximate height of a jaw is 0.5 inches (12.7 mm). The crosshead speed is 10+/−0.4 inches/min (254+/−1 mm/min), and the break sensitivity is set at 65%.

The sample is placed in the jaws of the instrument, centered both vertically and horizontally. The test is then started and ends when the specimen breaks. The peak load is recorded as either the “MD tensile strength” or the “CD tensile strength” of the specimen depending on the sample being tested. At least six (6) representative specimens are tested for each product and the arithmetic average of all individual specimen tests is either the MD or CD tensile strength for the product.

### Wet Tensile Testing

Wet tensile strength measurements are measured in the same manner, but are only typically measured in the cross-machine direction of the sample. Prior to testing, the center portion of the CD sample strip is saturated with room temperature distilled water immediately prior to loading the specimen into the tensile test equipment. CD wet tensile measurements can be made both immediately after the product is made and also after some time of natural aging of the product.

For mimicking natural aging, experimental product samples are stored at ambient conditions of approximately 23° C. and 50% relative humidity for up to 15 days or more prior to testing so that the sample strength no longer increases with time. Following this natural aging step, the samples are individually wetted and tested. Alternatively, samples may be tested immediately after production with no additional aging time. For these samples, the tensile strips are artificially aged for 5 or 10 minutes in an oven at 105° C. prior to testing. Following this artificial aging step, the samples are individually wetted and tested. For measuring samples that have been made more than two weeks prior to testing, which are inherently naturally aged, such conditioning is not necessary.

Sample wetting is performed by first laying a single test strip onto a piece of blotter paper (e.g., Fiber Mark, Reliance Basis 120). A pad is then used to wet the sample strip prior to testing. An example pad is a Scotch-Brite® brand (3M) general purpose commercial scrubbing pad. To prepare the pad for testing, a full-size pad is cut approximately 2.5 inches (63.5 mm) long by 4 inches (101.6 mm) wide. A piece of masking tape is wrapped around one of the 4 inch (101.6 mm) long edges. The taped side then becomes the “top” edge of the wetting pad. To wet a tensile strip, the tester holds the top edge of the pad and dips the bottom edge in approximately 0.25 inch (6.35 mm) of distilled water located in a wetting pan. After the end of the pad has been saturated with water, the pad is then taken from the wetting pan and the excess water is removed from the pad by lightly tapping the wet edge three times on a wire mesh screen. The wet edge of the pad is then gently placed across the sample, parallel to the width of the sample, in the approximate center of the sample strip. The pad is held in place for approximately one second and then removed and placed back into the wetting pan. The wet sample is then immediately inserted into the tensile grips so the wetted area is approximately centered between the upper and lower grips. The test strip should be centered both horizontally and vertically between the grips. (It should be noted that if any of the wetted portion comes into contact with the grip faces, the specimen must be discarded and the jaws dried off before resuming testing.) The tensile test is then performed and the peak load recorded as the CD wet tensile strength of this specimen. As with the dry tensile tests, the characterization of a product is determined by the average of six representative sample measurements.

### Ancillary Tensile Testing

In addition to tensile strength, stretch, slope and tensile energy absorbed (TEA) is also reported by the MTS TestWorks® for Windows Ver. 3.10 or 4.07B program for each sample measured. Stretch (either MD stretch or CD stretch) is reported as a percentage and is defined as the ratio of the slack-corrected elongation of a specimen at the point it generates its peak load divided by the slack-corrected gauge length. Slope is reported in the units of grams (g) or kilograms (kg) and is defined as the gradient of the least-squares line fitted to the load-corrected strain points falling between a specimen-generated force of 70 to 157 grams (0.687 to 1.540 N) divided by the specimen width. Total energy absorbed (TEA) is calculated as the area under the stress-strain curve during the same tensile test as previously described above. The area is based on the strain value reached when the sheet is strained to rupture and the load placed on the sheet has dropped to 65 percent of the peak tensile load. Since the thickness of a paper sheet is generally unknown and varies during the test, it is common practice to ignore the cross-sectional area of the sheet and report the “stress” on the sheet as a load per unit length or typically in the units of grams per 3 inches of width. For the TEA calculation, the stress is converted to grams per centimeter and the area calculated by integration. The units of strain are centimeters per centimeter so that the final TEA units become g-cm/cm².

### Bacteria Removal

The effectiveness of the products of this invention for removing germs from hard surfaces is determined by the “Germ Removal Test”, which is as follows. The wipe material is cut into a 5 cm×15 cm strip and is wet with 1 ml of sterilized deionized water. The wet strip is wrapped around a sample holder and is locked onto the mechanical moving arm of a Gardner Abrasion Tester (BYK-Gardner USA; Columbia, Md.) using the provided pins; a 1 kg weight is placed on top of the sample holder and locked in place using the provided nuts and bolts. A previously-sterilized 3 in×15 in smooth, non-porous ceramic tile is placed in the tray plate of the abrasion tester. The ceramic surface is inoculated with 1 ml of previously-prepared inoculum (Trypticase Soy Broth, TSA) containing S. aureus (ATCC-6538), and the inoculum is spread over the ceramic surface using a sterile disposable alginate tipped applicator. The S. aureus concentration should be approximately 10⁵ CFU/ml. The mechanical arm equipped with the test sample is placed on the tile surface, and the wiper is run for 10 cycles at the default speed setting of 9.2″/sec and a travel path length of 15″ and a total contact time of 16.3 seconds between wipe material and tile surface. The mechanical moving arm is removed from the tile surface. A sterile alginate swab saturated with Letheen broth (0.1%) is used to wipe the entire tile surface, and the alginate swab tip is placed in Letheen broth (7 ml). This sampling step is repeated two more times using a new sterile alginate swab each time. Serial dilutions (10¹ to 10⁴) of each of the sampling swabs are prepared, and each spin plated on sterile TSA plates with 5% sheep blood. The plates are incubated for 24 hrs at 35° C., and the bacteria count is read and recorded as bacteria not lifted. The bacteria lifted value is the difference between the inoculated concentration minus the bacteria not lifted.

### Color Testing

For purposes herein, certain color properties of the functional visual indicia (hue, luminosity and saturation/vividness) are measured as follows.

Quantitative colorimetric measurements can be made using a variety of commercially available colorimeters or spectrophotometers. Spectrophotometers and colorimeters are capable of both L*a*b* and LCH values. Such measurements and methods are well known in the art and are appropriate for determining hue, chroma and other properties of the images of the present invention when the indicia of the products of the present invention have an area of color of sufficient size for the aperture of the equipment such that the equipment can make a meaningful determination of these values.

Where the size of the indicia is such that a colorimeter or spectrophotometer is unsuitable for color determination of graphics, such as when the indicia may be composed of narrow lines or shapes whose width is much less than the instrument aperture, a Zeiss KS400 Image Analysis system may be preferentially used for colorimetric measurement.

The Zeiss KS400 image analysis incorporates a Zeiss AxioCam color CCD camera (1300×1030 pixels, 3 channel color, 8 bit per channel) having a 20 mm AF-Nikkor lens (f/2.8). The camera is mounted vertically facing down onto a sample stage and has an effective field of view of 97×80 mm. Incident sample stage illumination is effected by four incandescent floodlamps (Sylvania) on a double Variac (70%; 90%), resulting in an illuminance of approximately 11,000 lux. The lamps above the left and right edges of the sample stage are directed towards the field of view at approximately 45 degrees.

The camera black reference is determined with the lens cap on. The camera white reference is determined with a Polaroid 803 positive with 15 ms exposure. To account for the warm color illumination bias of floodlamps, the red, green, and blue (RGB) values were offset using the white selection tool in the KS400 software, resulting in corrected RGB values that yielded a white image.

Samples are placed on the stage (normal viewing angle) and under ¼″ plate glass to minimize topographical effects. Images of the color-bearing graphical portion are acquired at 15 ms exposure.

Image analysis is performed in Matlab (v.6.5.1, release 13; Mathworks, Inc) with the Image Processing Toolbox (v4.0). RGB images are converted to hue, saturation, and value (HSV) space using Matlab's hsv2rgb.m command. Choosing a saturation lower limit of 0.05 (0-1 scale) results in practical detection of all the colored/inked portions of the graphic. The hue, saturation, and value (i.e., luminosity) densiometric distributions are calculated for the detected regions in each image.

### BRIEF DESCRIPTION OF THE DRAWINGS

FIGS. 1-11 are examples of functional visual indicia suitable for purposes of this invention. It will be appreciated that many variations from these specific examples would be suitable for purposes of this invention.

### DETAILED DESCRIPTION OF THE DRAWINGS

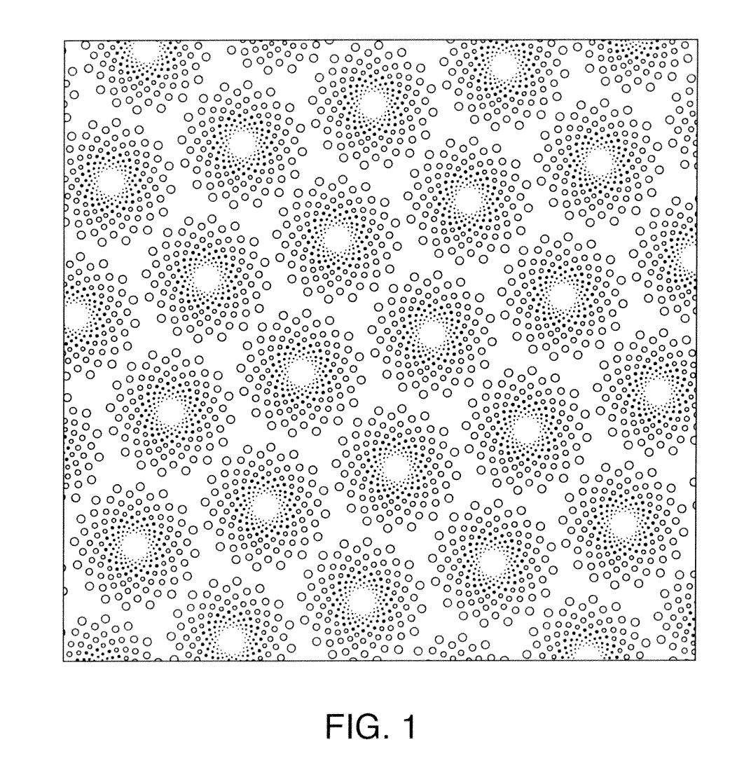

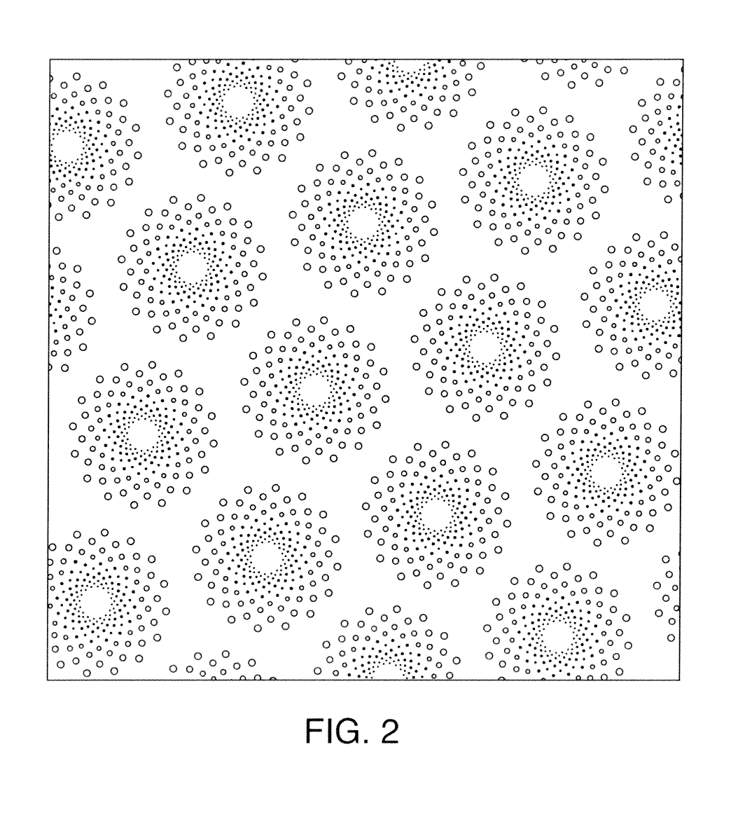

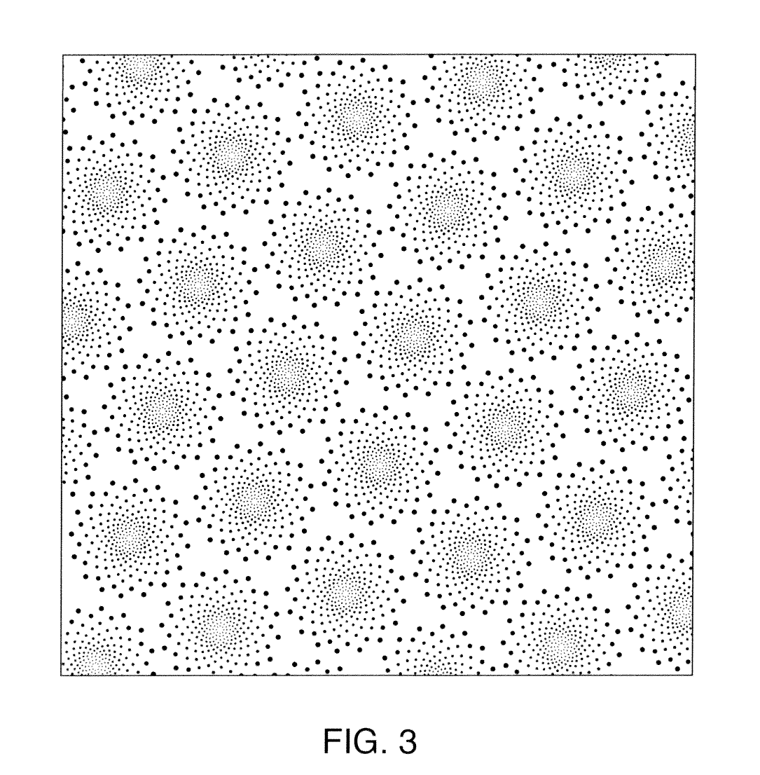

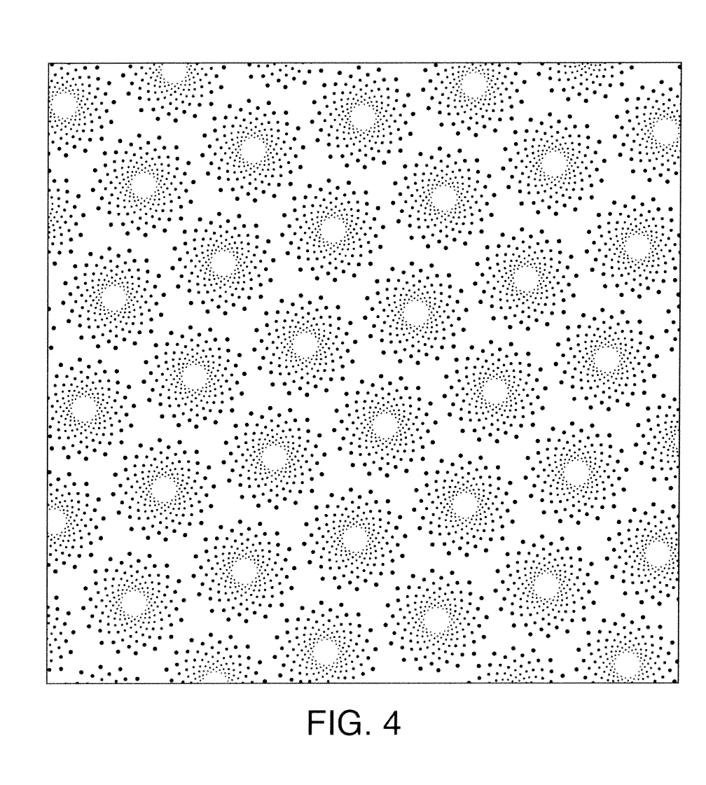

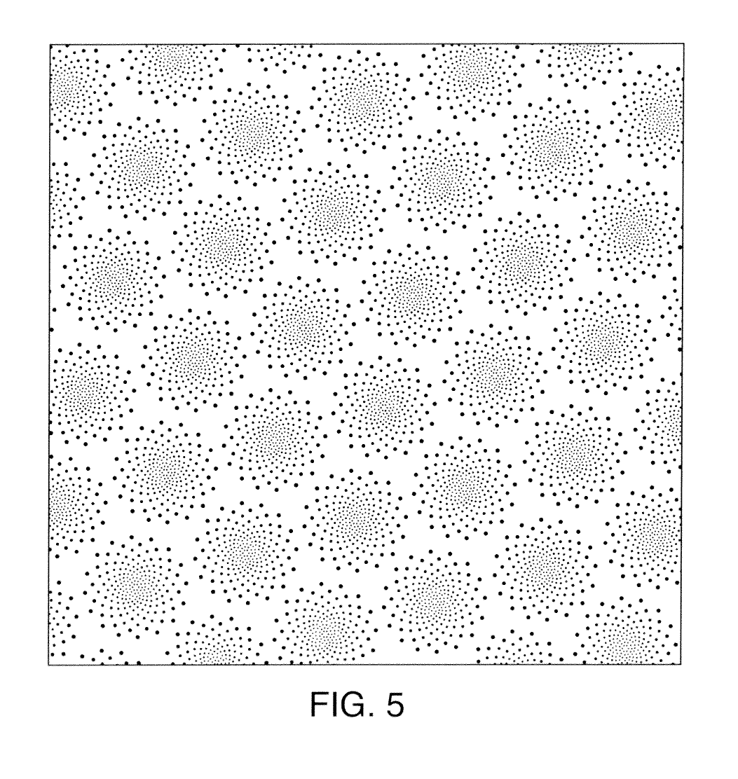

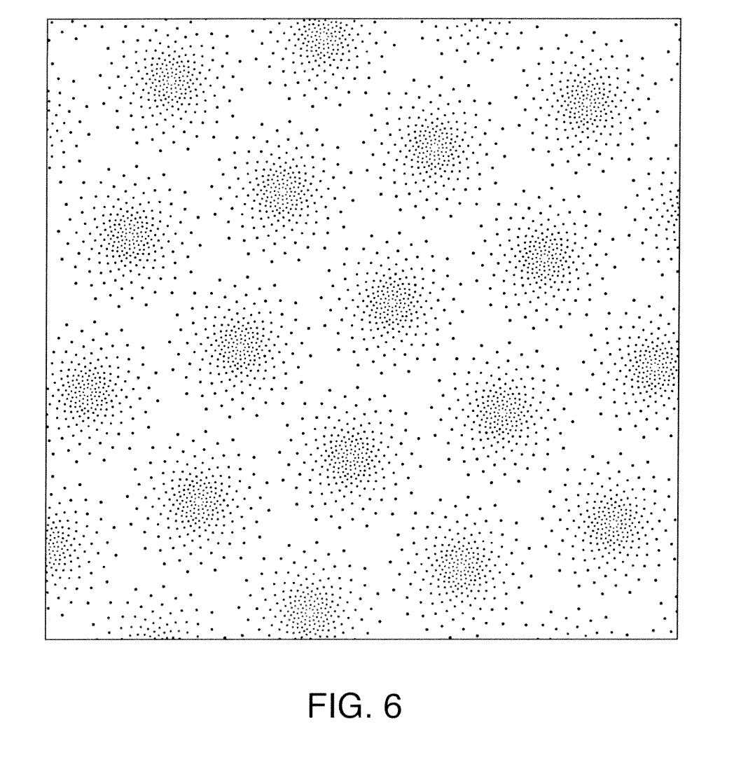

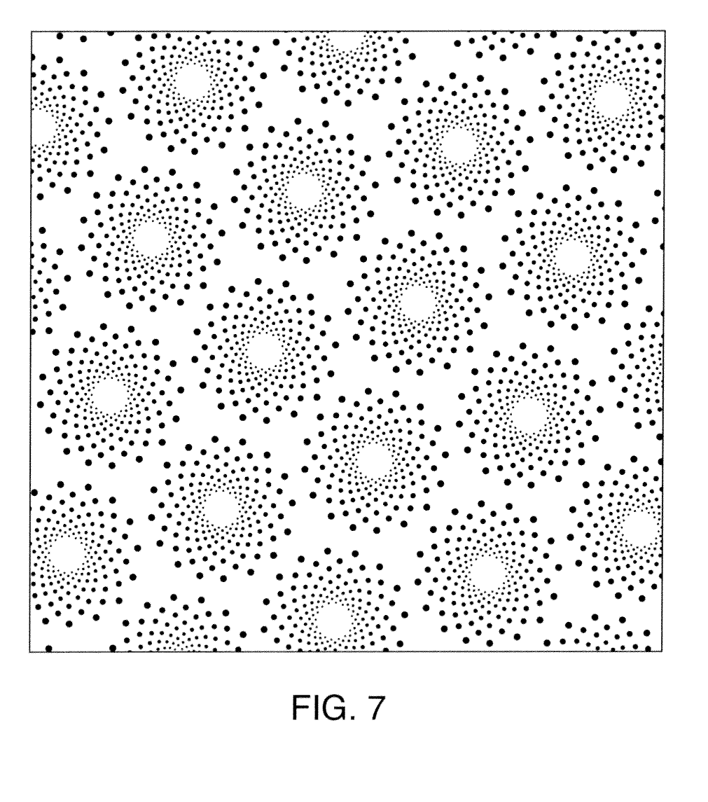

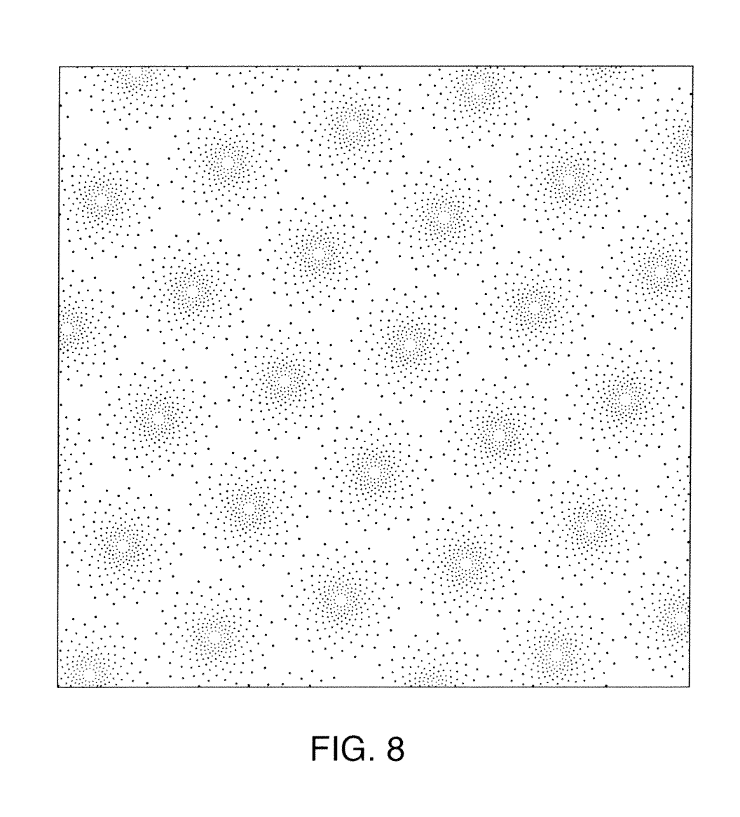

FIGS. 1-8 are variations of what is referred to herein as “kaleidoscope” patterns, which provide a repeating pattern of interesting expanding shapes imparted by dots of various sizes.

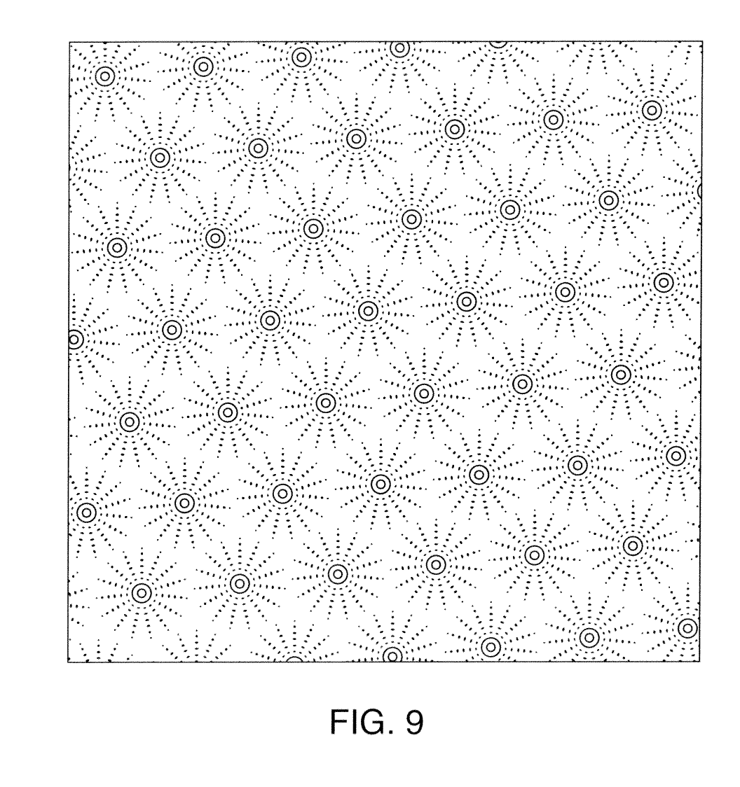

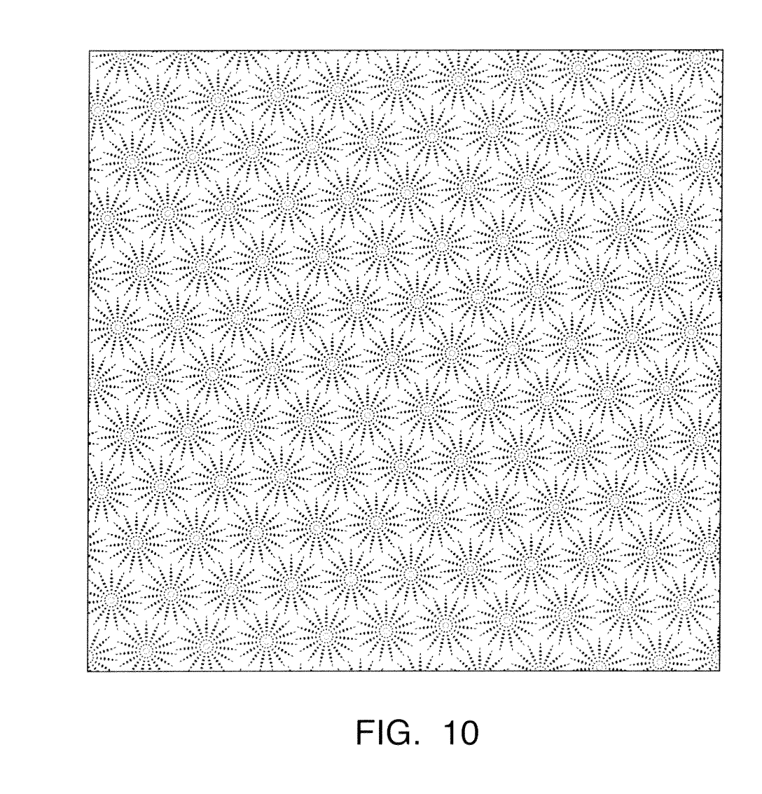

FIGS. 9-10 are what is referred to herein as a “starburst” pattern, which provides a repeating pattern of star-like shapes.

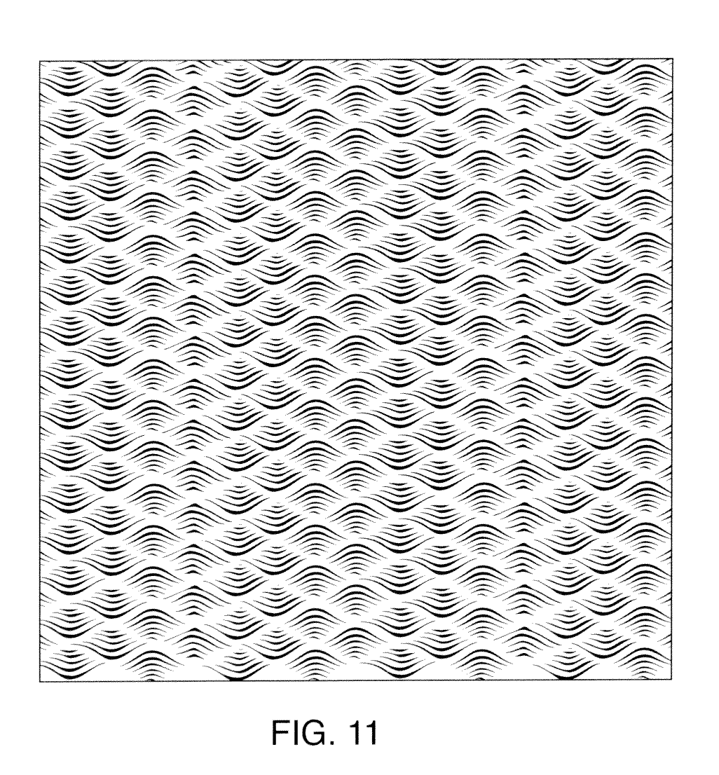

FIG. 11 is what is referred to herein as a “waves” pattern, which contains a series of undulating lines mimicking waves.

### EXAMPLES

### Example 1 (Invention)

Commercially produced paper towel parent rolls generally made in accordance with U.S. Pat. No. 7,462,258 B2 were slit to 16″ width and rewound. The rewound rolls were then printed with aluminum chlorohydrate (ACH), fragrance, and a blue ink functional indicia hereinafter described. The ACH solution (REACH 501 solution from Reheis, Inc. of Berkeley Heights, N.J.) was diluted with water from 50% ACH (as received solids) to 25% ACH. Mango-Lime fragrance having a fruity-citrus scent was obtained from Arylessence Inc. of Marietta, Ga. The blue ink was obtained from Sun Chemical Corporation of Menasha, Wis. and had a hue angle of 234° and a chroma value of 40.4, an L value of 64.63, a* value of −23.8 and a b* value of −32.7. The three fluids were applied to the sheets using an offset gravure printer with three print decks and one central impression drum. The ceramic anilox roll used for each printing step had 400 lines per inch (LPI) and a volume of 2.5 billions of cubic microns (BCM).

The ACH printing step transferred the ACH solution from the anilox roll to a solid rubber sleeve, which in turn transferred the ACH solution to the slit sheet. The print nip between the ceramic anilox roll and the solid rubber sleeve was set to transfer the required amount of ACH to the sheet. The print nip between the anilox roll and solid rubber sleeve was 7 mm. The gap between the solid rubber sleeve and central impression drum was set to 0.125 mm.

The fragrance printing step transferred the fragrance from the ceramic anilox roll to a patterned sleeve, which in turn transferred the fragrance to the slit sheet. The print nip between the ceramic anilox roll and the pattered sleeve was set to transfer the required amount of fragrance to the sheet. The fragrance comprised approximately 60% oil and 40% diluent. The fragrance add-on of approximately 0.5% by weight total of active scent plus diluent. The surface area coverage of the patterned scent covered the entire sheet, but on a micro-scale, the printed scent deposits covered approximately 8% of the surface of the sheet.

The blue ink printing step transferred the ink from the ceramic anilox roll to a patterned sleeve, which in turn transferred the blue ink to the sheet. The print nip between the ceramic anilox roll and the pattered sleeve was set to transfer the required amount of blue ink to the sheet. The patterned sleeve consisted of dots in a non-random, repeating pattern generally in accordance with the design described in U.S. Patent Application No. 2004/0118530 A1 entitled “Nonwoven products having a patterned indicia”, assigned to Kimberly-Clark Worldwide, Inc. Such a pattern is referred to herein as a “burst” pattern. The surface area coverage of the printed deposits was approximately 3% of the total sheet surface area. The individual burst pattern had a diameter of approximately 3.75″ with the individual burst patterns being spaced apart by about 4″ on center over the sheet in both directions.

The printed sheets were then converted into finished paper towel rolls. Using the Bacteria Removal test method described herein, the product of this Example 1 was found to remove 99.8% of S. Aureus with an inoculation of 9.5×10⁵ cfu/ml.

### Example 2 (Comparative)

Samples of commercially available unprinted white paper towels (Bounty® and VIVA®) were tested for their bacteria removing capability using the Bacteria Removal test method described herein by inoculating with S. Aureus at 6.8×10⁵ cfu/ml. The samples were found to respectively remove 99.1% and 99.7% of the S. Aureus demonstrating the ability of normal commercial paper towels to remove germs from hard surfaces.

### Example 3

A quantitative consumer use test (CUT) was conducted with primary household product purchasers who currently purchase either paper towels or anti-bacterial wipes and were positive/neutral to the unbranded inventive concept. Only 11% of consumers were disqualified for being negative to the concept. 188 consumers were placed with the inventive product in order to yield a sample size of 150. Respondents received one roll of the inventive product of Example 1 to evaluate over a seven day period. After the use period, follow-up interviews were used to obtain each respondent's evaluation of the inventive product in terms of overall appeal, performance on key attributes, tasks for which product was used, and problems experienced during use. As part of the follow-up interviews, participants were supplied with a list of tasks and asked to indicate whether or not they would use the product of the invention for the specific use or task. The participants were also asked whether they used current paper towels or moist disinfecting wipes for those same tasks. Results for specific cleaning tasks are shown in Table 1. Results show the percent of respondents that said they did/would use the particular product for the specific task. From Table 1 it is clear that the addition of scent and the indicia provides a synergistic effect for providing a reason to believe that a paper towel product is effective at germ control relative to a normal paper towel.

TABLE 1

| | Current | Inventive |
|---|---|---|
| Task | Paper Towel | Product |
| Removing germs from counters | 66 | 97 |
| and surfaces | | |
| Cleaning, wiping surfaces | 82 | 100 |
| Scrubbing | 66 | 89 |
| Cleaning up before and after food | 81 | 97 |
| preparation | | |
| Cleaning up pet messes | 64 | 71 |

While improving the perception of germ control relative to untreated paper towels, the inventive product also was perceived as having greater safety and utility relative to moist disinfecting wipes containing an effective amount of an EPA approved antimicrobial agent as shown by responses to the tasks shown in Table 2. As with the previous table, the numbers in the table represent the percentage of respondents that said they did/would use the specified product type for that task.

TABLE 2

| | Moist | |
|---|---|---|
| | Disinfecting | Inventive |
| Task | Wipes | Example |
| Cleaning glass and mirrors | 27 | 81 |
| Wiping/Drying hands | 18 | 74 |
| Wiping up spills and messes | 48 | 100 |
| Protecting/lining surfaces | 14 | 42 |
| Wiping faces | 18 | 32 |
| Using as a napkin | 11 | 42 |
| Use as a placemat | 11 | 29 |
| Absorbing grease from food | 17 | 51 |
| Washing/drying fruits and | 9 | 36 |
| vegetables | | |
| Cleaning up pet messes | 37 | 71 |

It will be appreciated that the foregoing description and examples, given for purposes of illustration, are not to be construed as limiting the scope of this invention, which is defined by the following claims and all equivalents thereto.

We claim:

1. A dry wiping product comprising a paper towel sheet containing a fragrance, which emits a cleaning-related scent, and a visual functional indicia consisting essentially of cool colors.

2. The product of claim 1 wherein the cleaning-related scent comprises a top note selected from the Wood scent category.

3. The product of claim 1 wherein the cleaning-related scent comprises a top note selected from the Fruity scent category.

4. The product of claim 1 wherein the cleaning-related scent comprises a top note selected from the Citrus scent category.

5. The product of claim 1 wherein the cleaning-related scent comprises a top note selected from the Aquatic scent category.

6. The product of claim 1 wherein the cleaning-related scent comprises a top note selected from the group consisting of lemon, lime, orange, aloe, cucumber, banana, raspberry, mango, apple, peach, pear, strawberry, grapefruit, mulberry, pineapple, melon, coconut and mixtures thereof.

7. The product of claim 1 wherein the cleaning-related scent comprises a lemon scent top note.

8. The product of claim 1 wherein the cleaning-related scent comprises a lime scent top note.

9. The product of claim 1 wherein the cleaning-related scent comprises an orange scent top note.

10. The product of claim 1 wherein the cleaning-related scent comprises a pine scent top note.

11. The product of claim 1 comprising an add-on amount of neat fragrance from about 0.01 to about 2 weight percent based on the dry weight of the paper towel sheet.

12. The product of claim 1 wherein the color of the visual functional indicia is selected from colors having a hue angle of from about 60° to about 300° on the Color Wheel.

13. The product of claim 1 wherein the color of the visual functional indicia is selected from colors having a hue angle of from about 90° to about 270°.

14. The product of claim 1 wherein the color of the visual functional indicia is selected from colors having a hue angle of from about 120° to about 240°.

15. The product of claim 1 wherein the visual functional indicia comprises colors from the same color family.

16. The product of claim 1 wherein the visual functional indicia is a geometric pattern.

17. The product of claim 1 wherein the visual functional indicia is a burst pattern.

18. The product of claim 1 comprising aluminum chlorohydrate.

19. The product of claim 1 which removes 99% or greater of germs from a hard, non-porous surface in accordance with the Germ Removal Test.
